(19) United States
(12) Patent Application Publication
(10) Pub. No.: US 2004/0202291 A1
(43) Pub. Date: Oct. 14, 2004

(54) Mobile phone with voice recording transfer function

(76) Inventor: Davey Nyle Skinner, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/228,727

(22) Filed: Aug. 27, 2002

(51) Int. Cl. H04M 1/64; H04M 11/10

(52) U.S. Cl. 379/67.1; 455/412.1

(57) ABSTRACT

A wireless mobile phone having voice recording, and method of operating the mobile phone. In one embodiment, a method for handling a voice recording with a wireless mobile phone comprises recording and storing a voice signal as a voice recording into at least one of an internal memory and a removable memory unit of the wireless mobile phone, and then electronically transferring the voice recording from the wireless mobile phone to an external target device.

### THE FIELD OF THE INVENTION

The present invention relates to mobile phones and in particular to mobile phones with voice recording capability.

### BACKGROUND OF THE INVENTION

Mobile phones have become a staple of the information age. We can be reached at anytime and in any place. Along with mobile phones, we also use laptop computers, pagers, and countless other devices to control our communications. Mobile phones permit communication via wireless telecommunications networks, as well as through the Internet and other networks. Consumer demand has pushed mobile phones, like other devices, to become increasingly smaller, more powerful, and capable of more functions, such as email and two-way messaging. Of course, some of these capabilities are possible only through the support of the wireless telecommunications network of the mobile phone, such as voice mail which is provided through a network facility external to the mobile phone.

As part of the technological revolution, voice recognition technology has been evolving to permit voice-to-text capability in word processing for computers. However, the pace of development in voice recognition technology has been closely tied to the development of the memory capacity and processing power of mainframe and desktop computers that are used to implement the voice recognition software. For many, this evolution has been too slow.

Despite the proliferation of handheld devices and their growing sophistication, mobile phones continue to lack the memory and power to handle more advanced computing functions that are performed by desktop computers. This shortcoming leaves the mobile phone quite dependent on its wireless telecommunications network, and limited in the number and type of functions provided by a mobile phone.

### SUMMARY OF THE INVENTION

The present invention provides a mobile phone capable of storing a voice recording, and method of operating the mobile phone. In one embodiment, a method of the present invention for handling a voice recording with a wireless mobile phone comprises recording and storing a voice signal as a voice recording into at least one of an internal memory and a removable memory unit of the wireless mobile phone, and then electronically transferring the voice recording from the wireless mobile phone to an external target device.

### BRIEF DESCRIPTION OF THE DRAWINGS

FIG. 1 is a block diagram of a voice recording transfer system for a wireless mobile phone, according to an embodiment of the present invention.

FIG. 2 is flow diagram of a method of handling a voice recording for a wireless mobile phone, according to an embodiment of the present invention.

FIG. 3 is a block diagram of voice recording transfer system for a pair of wireless mobile phones, according to an embodiment of the present invention.

FIG. 4 is a side view illustrating an atomic resolution storage device used in a voice recording transfer system, according to an embodiment of the present invention.

FIG. 5 is a simplified schematic diagram illustrating one exemplary embodiment of storing information within the atomic resolution storage device illustrated in FIG. 4.

FIG. 6 is a top view illustrating one exemplary embodiment of an atomic resolution storage device used in a voice recording transfer system in accordance with the present invention, taken along lines 6-6 of FIG. 4.

FIG. 7 is a diagram illustrating one exemplary embodiment of electron emitters reading from storage areas of the atomic resolution storage device of FIG. 4.

FIG. 8 is a diagram illustrating another exemplary embodiment of electron emitters reading from storage areas in an atomic resolution storage device, according to the present invention.

FIGS. 9a and 9b are top and profile views of a MRAM array for use in a voice recording transfer system, according to one embodiment of the present invention.

FIGS. 10a through 10c are profile and side views of a MRAM memory cell, which illustrate an orientation of magnetization of active and reference magnetic films, for use in a voice recording transfer system according to one embodiment of the present invention.

FIG. 11 is a profile view of a memory cell, its write lines, and magnetic fields generated by currents flowing through the write lines, for use in a voice recording transfer system, according to one embodiment of the present invention.

FIG. 12 is a block diagram of a voice recording transfer monitor, according to one embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

Components of the present invention may be implemented in hardware via a microprocessor, programmable logic, or state machine, in firmware, or in software within a given device. In one aspect, at least a portion of the software programming is web-based and written in HTML and JAVA programming languages, including links to graphical user interfaces, such as via windows-based operating system. The components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may reside in software on one or more computer-readable media. The term computer-readable media as used herein is defined to include any kind of memory, volatile or non-volatile, such as floppy disks, hard disks, CD-ROMs, flash memory, read-only memory (ROM), and random access memory (RAM).

Preferably, the user interfaces, such as a web browser, described herein run on a controller, computer, appliance or other device having an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employs a graphical user interface windowing environment which presents the applications or documents in specially delineated areas of the display screen called “windows.” The operating system preferably includes a windows-based dynamic display which allows for the entry or selection of data in dynamic data field locations via an input device such as a keyboard and/or mouse. One preferred operating system is a Windows® brand operating system sold by Microsoft Corporation. However, other operating systems which provide windowing environments may be employed, such as LINUX, UNIX, as well as those available from Apple Corporation or IBM. In another embodiment, the operating system does not employ a windowing environment.

A system and method of the present invention comprises using a wireless mobile phone to record and store a voice recording in the mobile phone and then electronically transfer the voice recording to an external target device for further storage, playback and/or transcription. A memory unit of the wireless mobile phone has a high capacity storage with low power and a small form factor to permit the wireless mobile phone to store large voice recording files, thereby insuring enough memory capacity to allow use as a voice recorder, in addition to its telecommunication functions. Moreover, using the wireless telecommunication functions and/or the removable feature of the removable storage media, the voice recording is transferable from the wireless mobile phone to an external target device for storage, playback, transcription, etc.

Combining the features of a dedicated voice recorder (e.g., Dictaphone) and the features of a wireless phone in a single unit eliminates the need for having two separate handheld devices and instantly enhances the portability of the digital voice recordings.

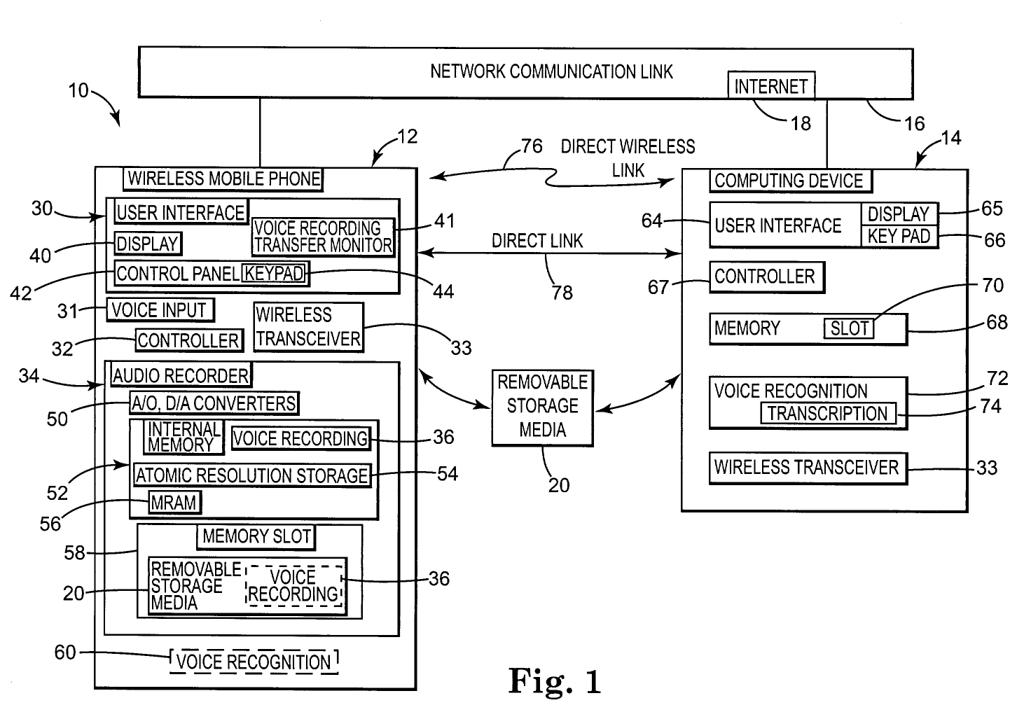

In one exemplary embodiment of the present invention, as shown in FIG. 1, voice recording transfer system 10 includes wireless mobile phone 12, computing device 14, and network communication link 16 with internet link 18, and removable storage media 20. Wireless mobile phone 12 comprises user interface 30, voice input 31 (e.g. microphone), controller 32, wireless transceiver 33, audio recorder 34, and optional voice recognition module 60. User interface 30 includes display 40 and control panel 42 with keypad 44. Audio recorder 34 stores voice recording 36 and includes AMD and D/A converter(s) 50, internal memory 52, and memory slot 58 for receiving removable storage media 20.

Internal memory 52 includes atomic resolution storage device 54, magnetic random access memory (MRAM) device 56, or another high capacity, low power, small form factor non-volatile memory unit.

Computing device 14 comprises user interface 64 with display 65 and keypad 66, controller 67, memory 68 with slot 70 for receiving removable storage media 20. Computing device 14 further comprises wireless transceiver 33 and voice recognition module 72 with optional transcription function 74.

Wireless mobile phone 12 and computing device 14 are in communication with each other via wireless link 76, direct link 78, and/or network communication link 16. In addition, data, such as voice recording 36, is transferable between wireless mobile phone 12 and computing device 14 via removable storage device 20.

Wireless mobile phone 12 is understood to include all components necessary for acting as a wireless telecommunications device, including but not limited to user interface 30, controller 32, and wireless transceiver 33. In the embodiment of the present invention, wireless mobile phone 12 additionally includes audio recorder 34 which acts as a voice recording mechanism for recording and storage of voice signals as a voice recording into wireless phone 12.

User interface 30 of wireless mobile phone 12 preferably comprises a graphical user interface with display 40 for viewing menu-driven selected functions of wireless mobile phone 12, which are activated using control panel 42 and keypad 44. For example, keypad 44 includes an alphanumeric keypad for dialing telephone numbers, entering email addresses, etc. Control panel 42 preferably includes designated portions of keypad 44 directed to controlling voice recording features and voice recording transfer functions of wireless mobile phone 12, such as start recording, stop recording, etc. User interface 30 optionally includes a touchscreen and/or pointing device for use in operating the voice recording and voice recording transfer functions.

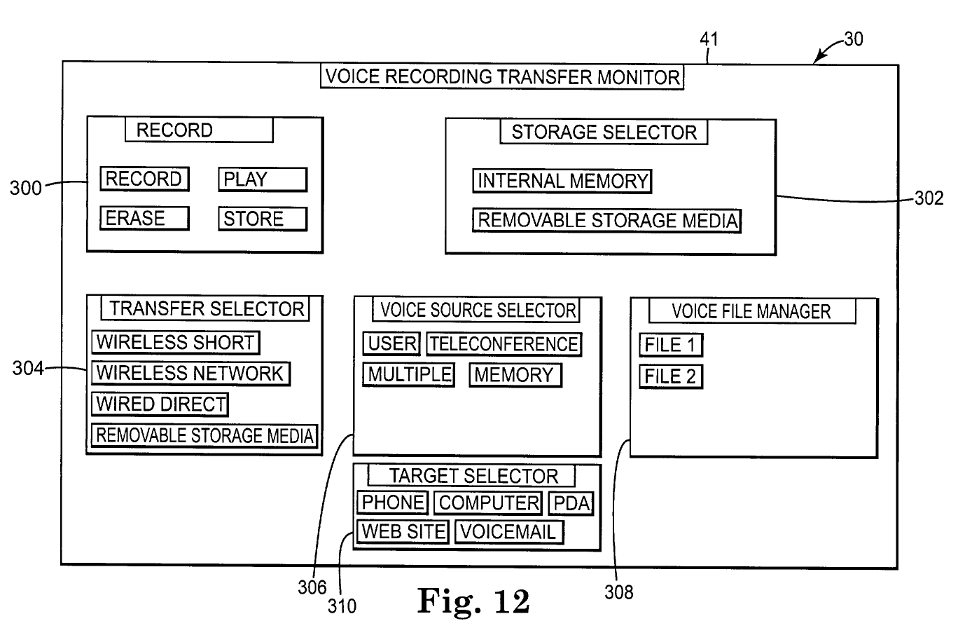

User interface 30 of wireless mobile phone 12 also optionally includes voice recording transfer monitor 41, which acts in cooperation with controller 32, to provide a command menu for operating the functions of wireless mobile phone 12. Voice recording transfer monitor 41 is also optionally operated by voice-activated commands handled by optional voice recognition module 60 with controller 32. Voice recording transfer monitor 41 of user interface 30 is further described in greater detail in association with FIG. 12. Finally, although voice recording transfer monitor 41 is illustrated as part of user interface 30, voice recording transfer monitor 41 also optionally is incorporated into audio recorder 34 and accessible by user interface 30.

Controller 32 of wireless mobile phone 12 preferably includes hardware, software, firmware or combination of these. In one preferred embodiment, controller 32 includes a microprocessor-based system capable of performing a sequence and logic operation and including memory for storing information. Controller 32 governs the interaction of the components of wireless mobile phone 12 and in particular, in cooperation with user interface 30, governs the storage and transfer of voice recordings 36 to and from internal memory 52 and/or removable storage media 20.

Wireless transceiver 33 of wireless mobile phone 12 enables wireless communication between wireless mobile phone 12 and computing device 14 (or other devices) via network communication link 16, as well as telecommunication links such as wireless phone networks. Network communication link 16, as used herein, includes an Internet communication link 18, an intranet communication link, or similar high-speed communication link.

Wireless transceiver 33 of wireless mobile phone 12 (and of computing device 14) also enables short range wireless communication between wireless mobile phone 12 and computing device 14 using other known communication protocols such as Wireless Application Protocol (WAP), Bluetooth, Infrared (IrDA, FIR), 802.11, and UltraWideBand (UWB). Wireless mobile phone 12 and computing device 14 each include communication hardware and software known in the art for implementing these protocols, such as wireless transceiver 33. Wireless communication protocols such as infrared (e.g., FiR), Bluetooth, and UltraWide Band (UWB) is represented by direct wireless link 76 and permit direct radio or beamed communication between two or more compatible devices that operate independently of a network and independently of network communication link 16. This feature permits direct one-on-one communication between two similarly configured devices without any communication intermediary. In the example of the Bluetooth protocol, the communication link preferably is established by the mere presence of each respective device in close proximity to each other.

Audio recorder 34 of wireless mobile phone 12 receives and records voice signals from voice input 31 as voice recording 36 in internal memory 52 and/or removable storage media 20. Audio recorder 34 includes A/D and D/A converters 50, which comprise analog-to-digital and digital-to-analog converters adapted for converting analog voice signals to digital voice signals and vice versa.

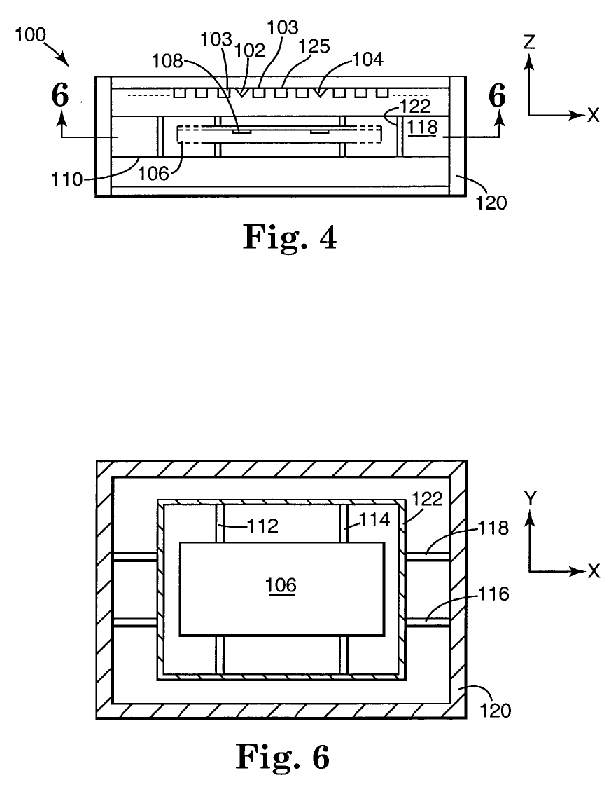

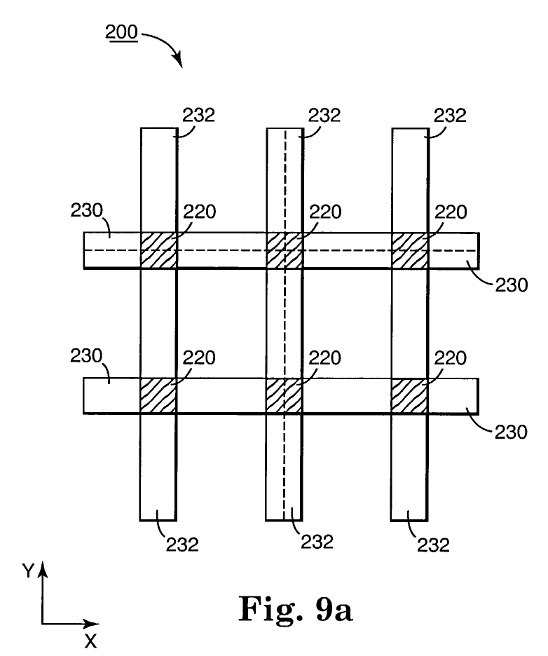

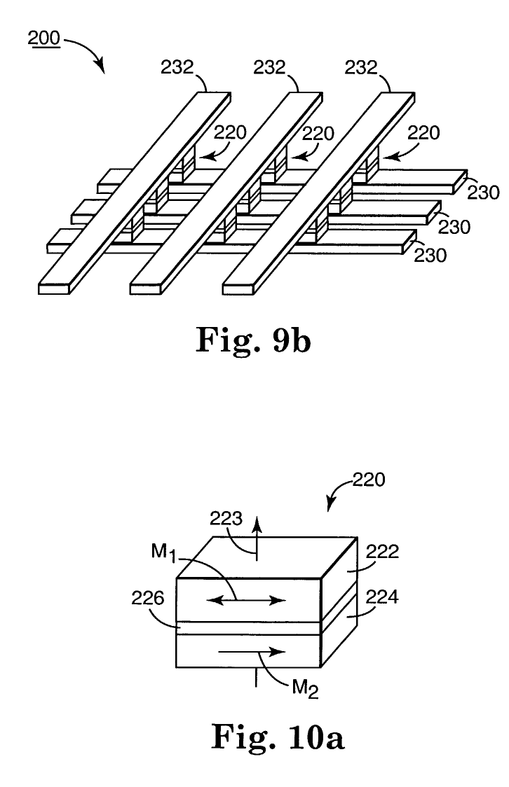

Internal memory 52 of audio recorder 34 of wireless mobile phone 12 stores digital voice recording(s) 36 and preferably comprises a non-volatile, high capacity memory unit with low power and a small form factor, such as atomic resolution storage (ARS) device 54, which is further described in association with FIGS. 4-8, or such as a magnetic random access memory (MRAM) device 56, which is further described in association with FIGS. 9-11.

Memory slot 58 of wireless mobile phone 12 is configured for receiving removable storage media 20. Removable storage media 20 comprises any form of non-volatile mobile computer-readable media such as read writeable (R/W) CD-ROM disks, floppy disks, flash memory cards, etc., which are capable of storing voice recording 36. Removable storage media 20 also optionally incorporates and/or comprises atomic resolution storage (ARS) device 54 or magnetic random access memory (MRAM) unit 56.

Wireless mobile phone 12 optionally includes voice recognition module 60, which converts voice signals from voice input 31 into text and/or commands recognizable by controller 32 for operating wireless mobile phone 12.

Computing device 14 preferably is a desktop computer, or other electronic computing device, such as a portable computer that is capable of receiving a transfer of voice recording 36 from wireless mobile phone 12 and capable of storing voice recording 36 in its memory 68. User interface 64 of computing device 14 includes substantially the same features as user interface 30, optionally including voice recording transfer monitor 41, for handling the transfer of voice recording 36. Memory 68 includes memory slot 70 for receiving removable storage media 20. Voice recognition module 72 with transcription function 74 is available for converting voice recording 36 into a text file. Wireless transceiver 33 includes substantially the same features as wireless transceiver 33 of wireless mobile phone 12 to permit wireless communication between computing device and wireless mobile phone 12 using any one of the transmission methods and/or communication protocols previously described.

System 10 optionally includes additional wireless mobile phones 12 in place of, or in addition to, computing device 14 for receiving a transfer of a voice recording from the first wireless mobile phone 12.

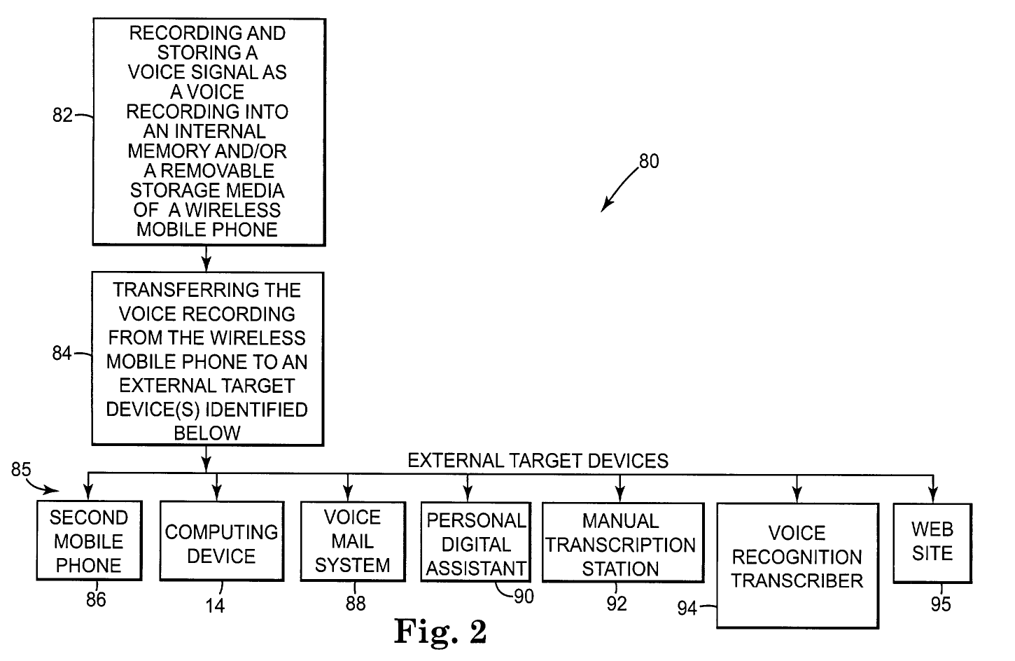

As shown in FIG. 2, method 80 for storing and transferring a voice recording with a wireless mobile phone, according to an embodiment of the present invention, uses wireless mobile phone 12 of system 10. Method 80 includes a first step 82 of recording and storing a voice signal received by wireless mobile phone 12 as voice recording 36 into internal memory 52 and/or removable storage media 20 of wireless mobile phone 12. In step 84, the voice recording is transferred from wireless mobile phone 12 to at least one of a plurality of external target devices 85 including any one, or all, of second wireless mobile phone 86, computing device 14, electronic voice mail system 88, personal digital assistant 90, manual transcription station 92, voice recognition transcriber 94, and web site 95.

Each of target devices 85 includes memory for storing voice recording 36 and is capable of receiving voice recording 36 via wireless transmission, wired transmission, network transmission (via network communication link 16), and/or removable storage media 20. In particular, any one of target devices 85 can be substituted for computing device 14 in system 10 shown in FIG. 1. Second wireless mobile phone 86 includes substantially the same features and attributes as wireless mobile phone 12. Electronic voice mail system 88 permits storage and playback of digital voice recordings 36, which are retrievable via wired or wireless telephone. Personal digital assistant 90 preferably is a handheld computing device and includes substantially the same features and attributes as computing device 14. Manual transcription station 92 comprises an electronic system for providing audio playback of voice recording 36 to permit transcription of voice recording 36 manually by a secretary or transcriptionist. Voice recognition transcriber 94 comprises a computing device that includes voice-recognition technology for electronically transcribing a digital voice recording into a text file for use by a word processor, text editor, printer, display, etc. Web site 95 is a site on the World Wide Web for posting and downloading voice recording(s) 36 from wireless mobile phone 12. Web site 95 is controlled by the user of wireless mobile phone 12 and/or is operated by third party service provider to allow multiple users of wireless mobile phones 12 to store and download voice recording(s) 36.

Step 82 of method 80 is typically includes capturing a voice signal from one or more persons speaking into wireless mobile phone 12. For example, a single user can speak into wireless mobile phone 12 when used as a voicepad or voice recorder. Control panel 42 of user interface 30 is used to stop and start recording, and optionally permits control via voice-activated commands with voice recognition module 60. In another example, wireless mobile phone 12 is used to record several voices in a conference setting, as well as during a telephone call and/or telephone conference with multiple parties. The voice signal received by phone 12, either through voice input 31 and/or receiving signal of phone 12 (a voice signal received by wireless mobile phone 12 from another telecommunications device such as a second wireless mobile phone), is directed by controller 32 for storage into internal memory 52 and/or removable storage media 20.

Step 84 of method 80 comprises transferring the stored voice recording 36 from wireless mobile phone 12 to an external target device 85. The transfer can occur in at least four ways. First, removable storage media 20 that contains voice recording 36 is removed from wireless mobile phone 12 and then inserted into one of external target devices 85. Second, voice recording 36 stored in internal memory 52 of wireless mobile phone 12 is transferred wirelessly over wireless link 76 to one of external target devices 85, such as second mobile phone 86. Third, voice recording 36 is transferred from internal memory 52 of wireless mobile phone 12 directly over wired link 78 into one of the target devices 85. Fourth, voice recording 36 is transferred from internal memory 52 of wireless mobile phone 12 through network communication link 16 to any one of the external target devices 85.

Method 80, with wireless mobile phone 12, permits a user to record, store and/or transfer voice recording 36 independent of a wireless telecommunications network (that supports wireless mobile phone 12) since the voice recording is stored directly in wireless mobile phone 12. In addition, voice recording 36 is transferable with or without the wireless telecommunications network of wireless mobile phone 12. Moreover, voice recording 36 is transferred to an external target device selected by the user through wireless mobile phone 12. Finally, the user enjoys the convenience of creating and handling voice recordings without the need for a separate dedicated voice recorder (e.g Dictaphone) in addition to the wireless mobile phone.

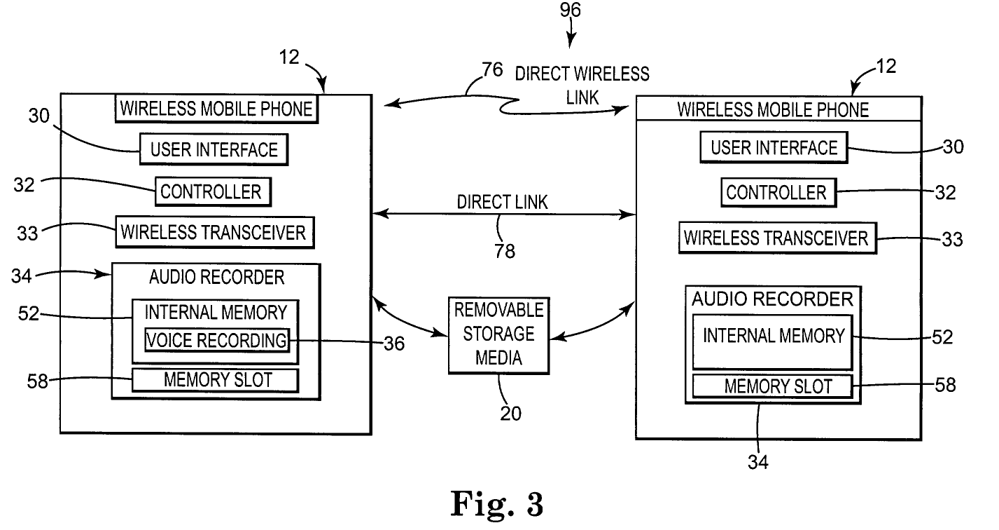

In another exemplary embodiment of the present invention, system 96 illustrates transfer of voice recording 36 between a pair of wireless mobile phones 12, 96. Each wireless mobile phone 12,96 includes substantially the same features and attributes as wireless mobile phone 12 described in association with FIG. 1. As shown in FIG. 3, wireless mobile phone 12,96 includes at least user interface 30, controller 32, wireless transceiver 33, and audio recorder 34 with memory 52 and slot 58. Wireless mobile phones 12,96 are in communication via direct wireless link 76 or direct link 78.

In use, wireless mobile phone 12 records a voice signal of the user as a voice recording 36 and stores that voice recording 36 in internal memory 52 and/or in removable storage media 20. Using method 80, voice recording 36 is transferred to wireless mobile phone 96 wirelessly via link 76, through wired transmission via link 78, or through removal of storage media 20 from wireless mobile phone 12 for insertion into memory slot 58 of wireless mobile phone 96.

Internal memory 52 of wireless mobile phone 12 comprises any one of several memory formats including an atomic resolution storage format. Atomic resolution storage module 54 of internal memory 52 is described in detail in association with FIGS. 4-8. FIGS. 4 through 8 disclose one exemplary embodiment of an atomic resolution storage device configured for use in memory 52 and being capable of storing megabytes to gigabytes of information in a small storage area. For a further discussion of an atomic resolution storage device, see U.S. Pat. No. 5,557,596, entitled, “Ultra-High Density Storage Device”, by Gibson et al. and assigned to Hewlett-Packard Company, and U.S. patent application Ser. No. 09/617,876 (Si-Ty Lam et al., filed Jul. 17, 2000, entitled “Self-Aligned Electron Source Device”) both of which are hereby expressly incorporated by reference.

FIG. 4 illustrates a side cross-sectional view of one exemplary embodiment of an atomic resolution storage device used in internal memory 52 of audio recorder 34 according to the present invention. As shown in FIG. 4, ARS storage device 100 is one exemplary embodiment of atomic resolution storage module 54 (shown in FIG. 1). Storage device 100 includes a number of electron emitters, such as electron emitters 102 and 104, storage medium 106 including a number of storage areas, such as storage area 108, and micromover 110. Micromover 110 scans storage medium 106 with respect to the electron emitters or vice versa. In one preferred embodiment, each storage area is responsible for storing one bit of information.

In one embodiment, the electron emitters are point emitters having very sharp points. Alternatively, other electron emitters may be used (e.g., flat or planar electron emitters). Each point emitter may have a radius of curvature in the range of approximately 1 nanometer to hundreds of nanometers. During operation, a pre-selected potential difference is applied between an electron emitter and its corresponding gate, such as between electron emitter 102 and gate 103 surrounding it. Due to the sharp point of the emitter, an electron beam current is extracted from the emitter towards the storage area. Depending on the distance between the emitters and the storage medium 106, the type of emitters, and the spot size (bit size) required, electron optics may be utilized to focus the electron beams. A voltage may also be applied to the storage medium 106 to accelerate the emitted electrons and to aid in focusing the emitted electrons.

In one embodiment, casing 120 maintains storage medium 106 in a partial vacuum, such as at least 10⁻⁵ torr. It is known in the art to fabricate such types of microfabricated electron emitters in vacuum cavities using semiconductor processing techniques. See, for example, “Silicon Field Emission Transistors and Diodes,” by Jones, published in IEEE Transactions on Components, Hybrids and Manufacturing Technology, 15, page 1051, 1992.

In the embodiment shown in FIG. 4, each electron emitter has a corresponding storage area. In another embodiment, each electron emitter is responsible for a number of storage areas. As micromover 110 scans storage medium 106 to different locations, each emitter is positioned above different storage areas. With micromover 110, an array of electron emitters can scan over storage medium 106.

As will be described, the electron emitters are responsible to read and write information on the storage areas by means of the electron beams they produce. Thus, electron emitters suitable for use in storage device 100 are the type that can produce electron beams that are narrow enough to achieve the desired bit density on the storage medium, and can provide the different power densities of the beams needed for reading from and writing to the medium. A variety of ways are known in the art that are suitable to make such electron emitters. For example, one method is disclosed in “Physical Properties of Thin-Film Field Emission Cathodes With Molybdenum Cones,” by Spindt et al, published in the Journal of Applied Physics, Vol. 47, No. 12, December 1976. Another method is disclosed in “Fabrication and Characteristics of Si Field Emitter Arrays,” by Betsui, published in Tech. Digest 4^{th} Int. Vacuum Microelectronics Conf., Nagahama, Japan, page 26, 1991.

In one embodiment, there can be a two-dimensional array of emitters, such as 100 by 100 emitters, with an emitter pitch of 5 to 50 micrometers in both the X and the Y directions. Each emitter may access tens of thousands to hundreds of millions of storage areas. For example, the emitters scan over the storage areas with a periodicity of about 1 to 100 nanometers between any two storage areas. Also, the emitters may be addressed simultaneously or sequentially in a multiplexed manner. Such a parallel accessing scheme significantly increases data rate of the storage device.

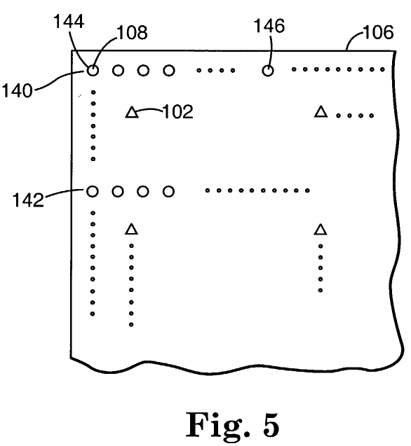

FIG. 5 shows the top view of storage medium 100 having a two-dimensional array of storage areas and a two-dimensional array of emitters. Addressing the storage areas requires external circuits. One embodiment to reduce the number of external circuits is to separate the storage medium into rows, such as rows 140 and 142, where each row contains a number of storage areas. Each emitter is responsible for a number of rows. However, in this embodiment, each emitter is not responsible for the entire length of the rows. For example, emitter 102 is responsible for the storage areas within rows 140 through 142, and within columns 144 through 146. All rows of storage areas accessed by one emitter are connected to one external circuit. To address a storage area, one activates the emitter responsible for that storage area and moves that emitter by micromover 110 (shown in FIG. 6) to that storage area. The external circuit connected to the rows of storage areas within which that storage area lies is activated.

Micromover 110 can also be made in a variety of ways, as long as it has sufficient range and resolution to position the electron emitters over the storage areas. As a conceptual example, micromover 110 is fabricated by standard semiconductor microfabrication process to scan storage medium 106 in the X and Y directions with respect to casing 120.

FIG. 6 shows the top view of the cross section 6-6 in FIG. 4, illustrating storage medium 106 held by two sets of thin-walled microfabricated beams. The faces of the first set of thin-walled beams are in the Y-Z plane, such as 112 and 114. Thin-walled beams 112 and 114 may be flexed in the X direction allowing storage medium 106 to move in the X direction with respect to casing 120. The faces of the second set of thin-walled beams are in the X-Z plane, such as 116 and 118. Thin-walled beams 116 and 118 allow storage medium 106 to move in the Y direction with respect to casing 120. Storage medium 106 is held by the first set of beams, which are connected to frame 122. Frame 122 is held by the second set of beams, which are connected to casing 120. The electron emitters scan over storage medium 106, or storage medium, 106 scans over the electron emitters in the X-Y directions by electrostatic, electromagnetic, piezoelectric, or other means known in the art. In this example, micromover 110 moves storage medium 106 relative to the electron emitters. A general discussion of such microfabricated micromover can be found, for example, in “Novel Polysilicon Comb Actuators for XY-Stages,” published in the Proceeding of MicroElectro Mechanical Systems 1992, written by Jaecklin et al.; and in “Silicon Micromechanics: Sensors and Actuators on a Chip”, by Howe et al., published in IEEE Spectrum, page 29, in July 1990.

In another embodiment, the electron beam currents are rastered over the surface of storage medium 106 by either electrostatically or electromagnetically deflecting them, such as by electrostatic deflectors or electrodes 125 positioned adjacent to emitter 104. Many different approaches to deflect electron beams can be found in literature on Scanning Electron Microscopy and will not be further described in this specification.

In one method, writing is accomplished by temporarily increasing the power density of the electron beam current to modify the surface state of the storage area. Reading is accomplished by observing the effect of the storage area on the electron beams, or the effect of the electron beams on the storage area. For example, a storage area that has been modified can represent a bit 1, and a storage area that has not been modified can represent a bit 0, and vice versa. In fact, the storage area can be modified to different degrees to represent more than two bits. Some modifications may be permanent, and some modifications may be reversible. The permanently modified storage medium is suitable for write-once-read-many memory (WORM).

In one embodiment, the basic idea is to alter the structure of the storage area in such a way as to vary its secondary electron emission coefficient (SEEC), its back-scattered electron coefficient (BEC), or the collection efficiency for secondary or back-scattered electrons emanating from the storage area. The SEEC is defined as the number of secondary electrons generated from the medium for each electron incident onto the surface of the medium. The BEC is defined as the fraction of the incident electrons that are scattered back from the medium. The collection efficiency for secondary/back-scattered electrons is the fraction of the secondary/back-scattered electrons that is collected by an electron collector and typically registered in the form of a current.

Reading is typically accomplished by collecting the secondary and/or back-scattered electrons when an electron beam with a lower power density is applied to storage medium 106. During reading, the power density of the electron beam should be kept low enough so that no further writing occurs.

One embodiment of storage medium 106 includes a material whose structural state can be changed from crystalline to amorphous by electron beams. The amorphous state has a different SEEC and BEC than the crystalline state, which leads to a different number of secondary and back-scattered electrons emitted from the storage area. By measuring the number of secondary and back-scattered electrons, one can determine the stage of the storage area. To change from the amorphous to crystalline state, one increases the beam power density and then slowly decreases it. This heats up the amorphous and then slowly cools it so that the area has time to anneal into its crystalline state. To change from crystalline to amorphous state, one increases the beam power density to a high level and then rapidly decreases the beam power. To read from the storage medium, a lower-energy beam strikes the storage area. An example of such type of material is germanium telluride (GeTe) and ternary alloys based on GeTe. Similar methods to modify states using laser beams as the heating source have been described in “Laser-induced Crystallization of Amorphous GeTe: A Time-Resolved Study,” by Huber and Marinero, published in Physics Review B 36, page 1595, in 1987, and will not be further described here.

There are many preferred ways to induce a state change in storage medium 106. For example, a change in the topography of the medium, such as a hole or bump, will modify the SEEC and BEC of the storage medium. This modification occurs because the coefficients typically depend on the incident angle of the electron beam onto the storage area. Changes in material properties, band structure, and crystallography may also affect the coefficients. Also, the BEC depends on an atomic number, Z. Thus, one preferred storage medium has a layer of low Z material on top of a layer of high Z material or vice versa, with writing accomplished through ablating some of the top layer by an electron beam.

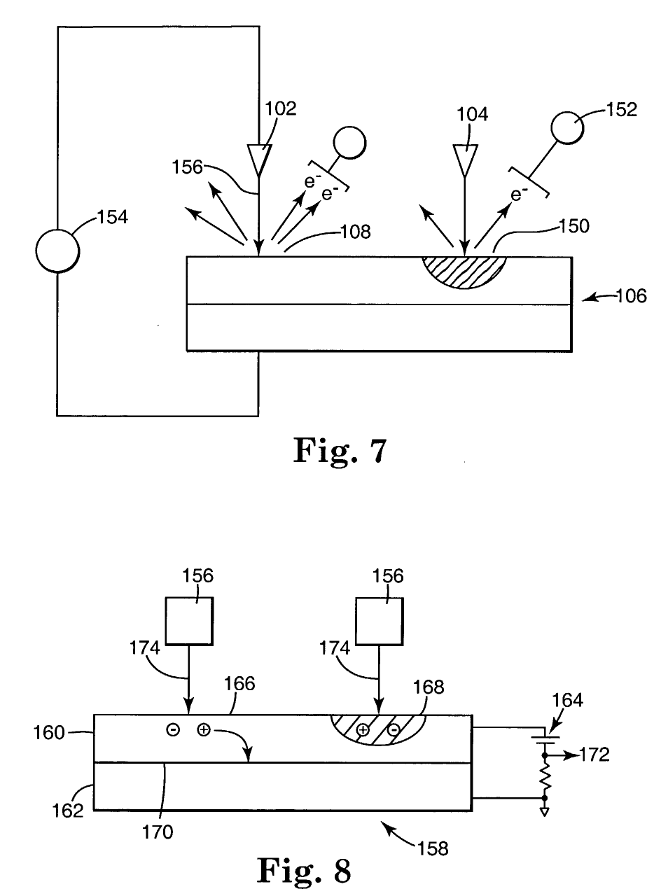

FIG. 7 shows schematically the electron emitters reading from storage medium 106. The state of storage area 150 has been altered, while the state of storage area 108 has not been altered. When electrons bombard a storage area, both secondary electrons and back-scattered electrons will be collected by the electron collectors, such as electron collector 152. An area that has been modified will produce a different number of secondary electrons and back-scattered electrons, as compared to an area that has not been modified. The difference may be more or may be less depending on the type of material and the type of modification. By monitoring the magnitude of the signal collected by electron collectors 152, one can identify the state of and, in turn, the bit stored in, the storage area.

In another reading approach, a diode structure is used to determine the state of the storage areas. According to this approach, the storage medium 158 is configured as a diode which can, for example, comprise a p-n junction, a schottky, barrier, or substantially any other type of electronic valve. FIG. 8 illustrates an example configuration of such a storage medium 158. It will be understood that alternative diode arrangements (such as those shown in U.S. Pat. No. 5,557,596) are feasible. As indicated in this figure, the storage medium 158 is arranged as a diode having two layers 160 and 162. By way of example, one of the layers is p type and the other is n type. The storage medium 158 is connected to an external circuit 164 that reverse-biases the storage medium. With this arrangement, bits are stored by locally modifying the storage medium 158 in such a way that collection efficiency for minority carriers generated by a modified region 166 is different from that of an unmodified region 168. The collection efficiency for minority carriers can be defined as the fraction of minority carriers generated by the instant electrons that are swept across a diode junction 170 of the storage medium 158 when the medium is biased by the external circuit 164 to cause a signal current 172 to flow through the external circuit.

In use, the electron emitters 156 emit narrow beams 174 of electrons onto the surface of the storage medium 158 that excite electron-hole pairs near the surface of the medium. Because the medium 158 is reverse-biased by the external circuit 164, the minority carriers that are generated by the incident electrons are swept toward the diode junction 170. Electrons that reach the junction 170 are then swept across the junction. Accordingly, minority carriers that do not recombine with majority carriers before reaching the junction 170 are swept across the junction, causing a current flow in the external circuit 164.

As described above, writing is accomplished by increasing the power density of electron beams enough to locally alter the physical properties of the storage medium 158. Where the medium 158 is configured as that shown in FIG. 8, this alteration affects the number of minority carriers swept across the junction 170 when the same area is radiated with a lower power density read electron beam. For instance, the recombination rate in a written (i.e., modified) area 166 could be increased relative to an unwritten (i.e., unmodified) area 168 so that the minority carriers generated in the written area have an increased probability of recombining with minority carriers before they have a chance to reach and cross the junction 170. Hence, a smaller current flows in the external circuit 164 when the read electron beam is incident upon a written area 166 than when it is incident upon an unwritten area 168. Conversely, it is also possible to start with a diode structure having a high recombination rate and to write bits by locally reducing the recombination rate. The magnitude of the current resulting from the minority carriers depends upon the state of particular storage area, and the current continues the output signal 172 to indicate the bit stored.

Internal memory 52 of audio recorder 34 of wireless mobile phone 12 also is optionally embodied as an MRAM memory device 56. Accordingly, MRAM memory module 56 of memory 52 of wireless mobile phone 12 is described in detail in association with FIGS. 9-11.

An MRAM device includes an array of memory cells. The typical magnetic memory cell includes a layer of magnetic film in which the magnetization is alterable and a layer of magnetic film in which the magnetization is fixed or “pinned” in a particular direction. The magnetic film having alterable magnetization may be referred to as a data storage layer and the magnetic film which is pinned may be referred to as a reference layer.

Conductive traces (commonly referred to as word lines and bit lines) are routed across the array of memory cells. Word lines extend along rows of the memory cells, and bit lines extend along columns of the memory cells. Located at each intersection of a word line and a bit line, each memory cell stores the bit of information as an orientation of a magnetization. Typically, the orientation of magnetization in the data storage layer aligns along an axis of the data storage layer that is commonly referred to as its easy axis. External magnetic fields are applied to flip the orientation of magnetization in the data storage layer along its easy axis to either a parallel or anti-parallel orientation with respect to the orientation of magnetization in the reference layer, depending on the desired logic state.

The orientation of magnetization of each memory cell will assume one of two stable orientations at any given time. These two stable orientations, parallel and anti-parallel, represent logical values of “1” and “0”. The orientation of magnetization of a selected memory cell may be changed by supplying current to a word line and a bit line crossing the selected memory cell. The currents create magnetic fields that, when combined, can switch the orientation of magnetization of the selected memory cell from parallel to anti-parallel or vice versa.

A selected magnetic memory cell is usually written by applying electrical currents to the particular word and bit lines that intersect at the selected magnetic memory cell. Typically, an electrical current applied to the particular bit line generates a magnetic field substantially aligned along the easy axis of the selected magnetic memory cell. The magnetic field aligned to the easy axis may be referred to as a longitudinal write field. An electrical current applied to the particular word line usually generates a magnetic field substantially perpendicular to the easy axis of the selected magnetic memory cell.

Preferably, only the selected magnetic memory cell receives both the longitudinal and the perpendicular write fields. Other magnetic memory cells coupled to the particular word line usually receive only the perpendicular write field. Other magnetic memory cells coupled to the particular bit line usually receive only the longitudinal write field. The magnitudes of the longitudinal and the perpendicular write fields are usually chosen to be high enough so that the selected magnetic memory cell switches its logic state when subjected to both longitudinal and perpendicular fields, but low enough so that the other magnetic memory cells which are subject only to either the longitudinal or the perpendicular write field do not switch.

FIG. 9 illustrates a top plan view of a simplified MRAM array 200. The array 200 includes memory cells 220, word lines 230, and bit lines 232. The memory cells 220 are positioned at each intersection of a word line 230 with a bit line 232. Most commonly, the word lines 230 and bit lines 232 are arranged in orthogonal relation to one another and the memory cells 220 are positioned in between the write lines (230,232), is illustrated in FIG. 9b. For example, the bit lines 232 can be positioned above the memory cells 220 and the word lines 230 can be positioned below.

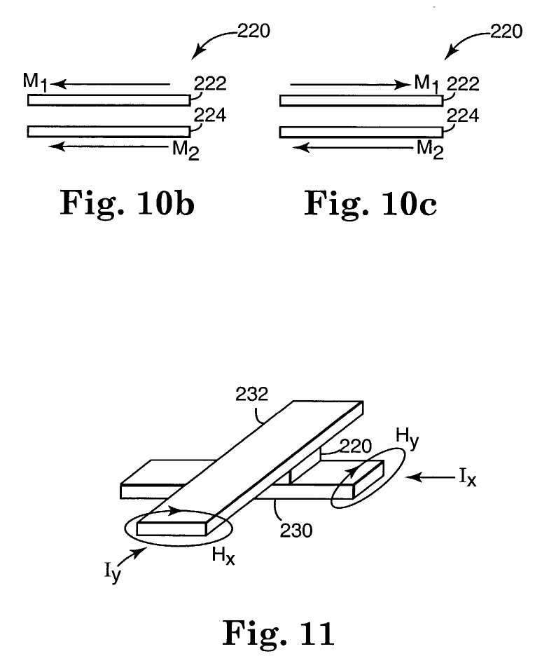

FIGS. 10a through 10c illustrate the storage of a bit of data in a single memory cell 220. In FIG. 10a, the memory cell 220 includes an active magnetic data film 222 and a pinned magnetic film 224 which are separated by a dielectric region 226. The orientation of magnetization in the active magnetic data film 222 is not fixed and can assume two stable orientations is shown by arrow M₁. On the other hand, the pinned magnetic film 224 has a fixed orientation of magnetization shown by arrow M₂. The active magnetic data film 222 rotates its orientation of magnetization in response to electrical currents applied to the write lines (230,232, not shown) during a write operation to the memory cell 220. The first logic state of the data bit stored in as memory cell 220 is indicated when M₁ and M₂ are parallel to each other as illustrated in FIG. 10b. For instance, when M₁ and M₂ are parallel a logic “1” state is stored in the memory cell 220. Conversely, a second logic state is indicated when M₁ and M₂ are anti-parallel to each other as illustrated in FIG. 10c. Similarly, when M₁ and M₂ are anti-parallel a logic “0” state is stored in the memory cell 220. In FIGS. 10b and 10c the dialectic region 226 has been omitted. Although FIGS. 10a through 10c illustrate the active magnetic data film 222 positioned above the pinned magnetic film 224, the pinned magnetic film 224 can be positioned above the active magnetic data film 222.

The resistance of the memory cell 220 differs according to the orientations of M₁ and M₂. When M₁ and M₂ are anti-parallel, i.e., the logic “0” state, the resistance of the memory cell 220 is at its highest. On the other hand, the resistance of the memory cell 220 is at its lowest when the orientations of M₁ and M₂ are parallel, i.e., the logic “1” state. As a consequence, the logic state of the data bit stored in the memory cell 220 can be determined by measuring its resistance. The resistance of the memory cell 220 is reflected by a magnitude of a sense current 223 (referring to FIG. 10a) that flows in response to read voltages applied to the write lines (230,232).

In FIG. 11, the memory cell 220 is positioned between the write lines (230,232). The active and pinned magnetic films (222,224) are not shown in FIG. 11. The orientation of magnetization of the active magnetic data film 222 is rotated in response to a current Iₓ that generates a magnetic field H_{y} and a current I_{y} that generates a magnetic field Hₓ. The magnetic fields Hₓ and H_{y} act in combination to rotate the orientation of magnetization of the memory cell 220.

FIG. 12 illustrates voice recording transfer monitor 41, which optionally forms a portion of user interface 30 (shown in FIG. 1). Voice recording transfer monitor 41 is a graphical user interface that appears on display 40 and which facilitates controlling operation of wireless mobile phone 12 to make and store voice recordings and/or transfer them to a designated target. Voice recording transfer monitor 41 includes record function 300, storage selector 302, transfer selector 304, voice source selector 306, voice file manager 308, and target selector 310.

Record function 300 of voice recording transfer monitor 41 enables selection of the various functions of recording, playback, storage, and erasing voice recording 36 from internal memory 52 and/or removable storage media 20 (FIG. 1). Storage selector 302 permits designating storage and/or retrieval of voice recording 36 from internal memory 52 and/or removable storage media 20.

Transfer selector 304 of voice recording transfer monitor 41 facilitates selecting a transmission or transfer method including short range wireless transmission (e.g., Bluetooth), wireless network (e.g., wireless telecommunications), wired direct transmission (e.g., direct cord connection) and removable storage media (e.g., transfer of removable storage media 20 between wireless mobile phone 12 and an external target device 85).

Voice source selector 306 of voice recording transfer monitor 41 enables selecting the source of voice input to be recorded and/or transferred by wireless mobile phone 12. Sources include recording the voice of the user, multiple voices during a telephone conversation, teleconference voicing, and using a voice from memory (e.g. internal memory 52, removable storage media 20).

Voice file manager 308 tracks an index of files of voice recordings that are stored in memory 52 and/or on removable storage media 20. These voice recording files can be selected for use with any one of the functions of record function 300, transfer selector 304, and/or storage selector 302.

Finally, voice recording transfer monitor 41 includes target selector 310 for selecting an external target device 85 (FIG. 2) to receive voice recording 36 from wireless mobile phone 12 and includes but is not limited to a phone (e.g., wireless mobile phone 86), personal digital assistant (e.g., PDA 90), and voice mail (e.g., voice mail system 88).

A system and method of the present invention comprises using a wireless mobile phone to record and store a voice recording in the phone and then electronically transfer the voice recording to a target device for further storage, playback and/or transcription. A memory unit, such as atomic resolution storage device or MRAM storage device, facilitates this method by providing a high capacity, low power, small form factor memory unit.

This system and method permits a user to record, stored and/or transfer a voice recording independent of a wireless telecommunications network since the voice recording is stored directly in wireless mobile phone. In addition, the voice recording is transferable with or without wireless telecommunications network of the wireless mobile phone. Moreover, the voice recording is transferred to an external target device selected by the user through the wireless mobile phone. Finally, the user enjoys the convenience of creating and handling voice recordings without the need for a separate dedicated voice recorder (e.g., Dictaphone) in addition to the wireless mobile phone.

While specific embodiments have been illustrated and described, herein for purposes of description of the preferred embodiment, it will be appreciated by those of ordinary skill in the art that a wide variety of alternate and/or equivalent implementations may be substituted for the specific embodiments shown and described without departing from the scope of the present invention.

Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A wireless mobile phone comprising:
a single housing comprising:
a wireless telecommunication mechanism; and
an audio recorder configured for recording a voice signal, configured for storing the voice signal as a voice recording, and configured for directing transfer of the voice recording to an external target device, wherein the audio recorder includes a non-volatile memory unit comprising an atomic resolution storage unit for storing the voice recording.

2. The phone of claim 1 wherein the audio recorder comprises a voice recording transfer monitor including at least one of:
a transfer selector configured for selecting a transfer path including at least one of short range wireless communication, wireless network communication, wired direct communication, and transfer by removable storage media;
a voice source selector configured for selecting a source of the voice input signal from at least one of a user, the memory unit, a teleconference, and a multiple user environment; and
a recording function configured for selecting at least one of the following functions:
recording a voice signal, playing a voice recording, erasing a voice recording, and storing a voice recording.

3. The phone of claim 1 wherein the audio recorder comprises a target selector configured to select the external target to include at least one of the following devices:
a second wireless mobile phone;
a computing device;
a voice mail system;
a personal digital assistant;
a manual transcription station;
a voice recognition transcriber; and
a web site.

4. The phone of claim 1 wherein the atomic resolution storage device includes:
a plurality of electron emitters, a media having media partitions, and a plurality of micromovers wherein each micromover is independently operable to move a media partition relative to one or more electron emitters for reading and writing data at the media.

5. A wireless mobile telephone comprising:
a single housing comprising:
a wireless telecommunication mechanism; and
an audio recorder configured for recording a voice signal, configured for storing the voice signal as a voice recording, and configured for directing transfer of the voice recording to an external target device, wherein the audio recorder includes a non-volatile memory unit comprising an magnetic random access memory unit for storing the voice recording.

6. The telephone of claim 5 wherein the magnetic random access memory storage unit comprises:
an array of memory cells including a data storage layer of magnetic film with alterable magnetization and a reference layer of magnetic film with fixed magnetization and including a plurality of conductive word lines extending along rows of the memory cells and a plurality of conductive bit lines extending along columns of the memory cells.

7. The phone of claim 5 wherein the audio recorder comprises a voice recording transfer monitor including at least one of:
a transfer selector configured for selecting a transfer path including at least one of short range wireless communication, wireless network communication, wired direct communication, and transfer by removable storage media;
a voice source selector configured for selecting a source of the voice input signal from at least one of a user, the memory unit, a teleconference, and a multiple user environment;
a recording function configured for selecting at least one of the following functions:
recording a voice signal, playing a voice recording, erasing a voice recording, and storing a voice recording; and
a target selector configured to select the external target to include at least one of the following devices a second wireless mobile phone, a computing device, a voice mail system, a personal digital assistant, a manual transcription station, a voice recognition transcriber; and a website.

8. A digital voice recording transfer system comprising:
means for digitally recording a voice signal, and for storing the digital voice recording, in a wireless mobile phone; and
means for electronically transferring the digital voice recording from the mobile phone to an external target device.

9. The system of claim 8 wherein the means for digitally recording includes a voice input for receiving the voice signal and at least one of an internal memory unit and a removable storage media for storing the digital voice recording.

10. The system of claim 8 herein means for electronically transferring the file comprises at least one of:
a wireless transceiver configured for wirelessly transmitting the digital voice recording from the means for digital recording to the external target device;
a direct connection link configured for directly transrmitting the file from the means for digital recording to the target device; and
a removable storage media of the means for storing the digital voice recording configured for removal from the means for storing and configured for insertion into the external target device.

11. The system of claim 8 wherein the means for electronically transferring includes a target selector configured for selecting one of the following target devices:
a second wireless mobile phone;
a computing device;
a voice mail system;
a personal digital assistant;
a manual transcription station;
a voice recognition transcriber;
and a website.

12. A method of handling a voice recording comprising:
recording and storing a voice signal as a voice recording into at least one of an internal memory and a removable memory unit of a wireless mobile phone; and
electronically transferring the voice recording file from the wireless mobile phone to an external storage device.

13. The method of claim 12 wherein electronically transferring comprises:
wirelessly transmitting the recorded voice signal to at least one of:
a voice recognition transcriber configured to store and to electronically transcribe the voice recording; and
a transcription station configured to store and to play the voice recording for manual transcription of the voice recording; and
a voice mail system configured to store and play the voice recording.

14. The method of claim 12 wherein recording the voice signal comprises:
removably inserting a memory unit into the wireless mobile phone and storing the voice recording on the memory unit; and
wherein electronically transferring the voice recording comprises:
removing the memory unit from the wireless mobile phone and inserting the memory unit into the external target device.

15. A method of voice transcription comprising:
recording and storing a voice signal as a digital voice recording into at least one of an internal memory and a removable memory unit of a wireless mobile phone;
wirelessly transmitting the recorded voice signal to at least one of:
a voice recognition transcriber configured to store and to electronically transcribe the voice recording; and
a manual transcription station configured to store and to play the voice recording for manual transcription of the voice recording.

16. A method of transferring a digital voice recording comprising:
recording and storing a voice signal as a digital voice recording in a removable internal storage media removably inserted into a wireless mobile phone; and
removing the storage media from the wireless mobile phone and inserting the storage media memory unit into a target device.

17. A voice recording transfer monitor of a wireless mobile phone for directing transfer of a voice recording form the wireless mobile phone to an external target device, the monitor comprising:
a transfer selector configured for selecting a transfer path of the voice recording including at least one of short range wireless communication, wireless network communication, wired direct communication, and transfer by removable storage media;
a voice source selector configured for selecting a source of the voice input signal from at least one of a user, the memory unit, a teleconference, and a multiple user environment;
a recording function configured for selecting at least one of the following functions:
recording a voice signal, playing a voice recording, erasing a voice recording, and storing a voice recording; and
a target selector configured to select the external target to include at least one of the following devices a second wireless mobile phone, a computing device, a voice mail system, a personal digital assistant, a manual transcription station, a voice recognition transcriber;
and a web site.

18. A computer-readable medium having computer-executable instructions for performing a method of transferring a digital voice recording, the method comprising:
recording and storing a voice signal as a voice recording into at least one of an internal memory and a removable memory unit of a wireless mobile phone;
electronically transferring the voice recording file from the wireless mobile phone to an external storage device.

19. A computer-readable medium having computer-executable instructions for performing a method of directing transfer of a voice recording from a wireless mobile phone to an external target device, the method comprising:
selecting a transfer path of the voice recording including at least one of short range wireless communication, wireless network communication, wired direct communication, and transfer by removable storage media;
selecting a source of a voice input signal to obtain the voice recording from at least one of a user, the memory unit, a teleconference, and a multiple user environment;
selecting at least one of the following functions: recording a voice signal, playing a voice recording, erasing a voice recording, and storing a voice recording; and
selecting the external target to include at least one of the following devices:
a second wireless mobile phone;
a computing device;
a voice mail system;
a personal digital assistant;
a manual transcription station;
a voice recognition transcriber;
and a web site.
